(19) United States
(12) Patent Application Publication
(10) Pub. No.: US 2026/0169592 A1
(43) Pub. Date: Jun. 18, 2026

(54) TOUCH SENSOR DRIVING CIRCUIT AND DISPLAY DEVICE INCLUDING THE SAME

(71) Applicant: LG Display Co., Ltd., Seoul (KR)

(72) Inventor: Sung Chul KIM, Paju-si (KR)

(73) Assignee: LG Display Co., Ltd., Seoul (KR)

(21) Appl. No.: 19/365,129

(22) Filed: Oct. 21, 2025

(30) Foreign Application Priority Data
Dec. 16, 2024 (KR) 10-2024-0187100

(51) Int. Cl. G06F 3/041

(52) U.S. Cl. CPC G06F 3/04186

(57) ABSTRACT

A touch sensor driving circuit and a display device including the same are disclosed. A touch sensor driving circuit includes a sensing circuit including a differentiator configured to differentiate a voltage difference between both ends of a sensing resistor connected to a touch wire and an integrator configured to integrate a signal output from the differentiator; and a driving circuit configured to control an integration time of the integrator based on a positive peak value or a negative peak value of the signal output from the differentiator.

### CROSS-REFERENCE TO RELATED APPLICATION

This application claims priority to and the benefit of Korean Patent Application No. 10-2024-0187100, filed Dec. 16, 2024, the disclosure of which is incorporated herein by reference in its entirety.

### BACKGROUND

### Field

The present disclosure relates to a touch sensor driving circuit and a display device including the same.

### Discussion of Related Art

A driving circuit of a display device reproduces an input image on a pixel array by writing pixel data of the input image to pixels of a display panel. The display device includes a display panel driving circuit such as a data driving circuit that supplies pixel data signals to data lines and a gate driving circuit that supplies gate signals (or scan signals) to gate lines (or scan lines). A display device includes a control circuit that controls the data driving circuit and the gate driving circuit, for example, a timing controller.

A touch screen may be provided on a screen of a display device. In this case, a display panel driving circuit may further include a touch sensor driving circuit that drives touch sensors of the touch screen.

### SUMMARY

The touch sensor driving circuit extracts a current change amount using a differentiator, accumulates the current change amount using an integrator, and determines whether a touch is performed using an accumulated value.

However, since a signal output from the differentiator has a certain period and has positive values and negative values, the positive values and the negative values may cancel each other while being accumulated in the integrator. Accordingly, various measures for accumulating the current change amount without cancellation are required or desired.

The present disclosure is directed to, among other things, solving some or all the above-described needs and problems.

The present disclosure provides a touch sensor driving circuit and a display device including the same.

It should be noted that objects of the present disclosure are not limited to the above-described objects, and other objects of the present disclosure will be apparent to those skilled in the art from the following descriptions.

A touch sensor driving circuit according to one or more example embodiments of the present disclosure may include a sensing circuit including a differentiator configured to differentiate a voltage difference between both ends of a sensing resistor connected to a touch wire and an integrator configured to integrate a signal output from the differentiator; and a driving circuit configured to control an integration time of the integrator based on a positive peak value or a negative peak value of the signal output from the differentiator.

A display device according to one or more example embodiments of the present disclosure may include a display panel including a plurality of pixels provided in areas where a plurality of data lines and a plurality of gate lines intersect each other and connected to one cathode electrode; and a touch sensor driving circuit configured to sense a current change of a touch wire connected to the cathode electrode, wherein the touch sensor driving circuit includes a sensing circuit including a differentiator configured to differentiate a voltage difference between both ends of a sensing resistor connected to the touch wire and an integrator configured to integrate a signal output from the differentiator; and a driving circuit configured to control an integration time of the integrator based on a positive peak value or a negative peak value of the signal output from the differentiator.

According to example embodiments of the present disclosure, it is possible to stably determine whether a touch is performed, without cancellation of a current change amount by setting an integration time with predetermined magnitude before a generation time of a peak value with a generation time of a positive or negative peak value of a signal output from a differentiator as a reference.

According to example embodiments of the present disclosure, since a direct-current component is removed during current sensing, and common noise between touch wires, touch sensitivity can be increased with an increase in current change amount, and as a result, touch performance can be improved.

According to example embodiments of the present disclosure, since an integration time of an integrator is reduced, low power driving can be achieved.

The effects of the present specification are not limited to the above-mentioned effects, and other effects that are not mentioned can be readily understood by those skilled in the art from the following description and the appended claims.

### BRIEF DESCRIPTION OF THE DRAWINGS

The accompanying drawings, which are included to provide a further understanding of the present disclosure and are incorporated in and constitute a part of this application, illustrate example embodiments of the present disclosure and together with the description serve to explain various principles of the disclosure. In the drawings:

FIG. 1 is a block diagram illustrating a display device according to one or more example embodiments of the present disclosure;

FIG. 2 is a diagram illustrating a touch unit according to one or more example embodiments of the present disclosure;

FIG. 3 is a diagram illustrating an example cross section of a display panel corresponding to the touch unit illustrated in FIG. 2;

FIGS. 4 and 5 are diagrams illustrating a sensing principle according to one or more example embodiments of the present disclosure;

FIG. 6 is a diagram illustrating a sensing circuit according to a first example embodiment of the present disclosure;

FIG. 7 is a diagram illustrating input and output voltages of the sensing circuit illustrated in FIG. 6;

FIGS. 8A and 8B are diagrams illustrating a sensing principle according to one or more example embodiments of the present disclosure;

FIGS. 9A and 9B are diagrams illustrating an integration time setting principle according to one or more example embodiments of the present disclosure;

FIGS. 10A and 10B are diagrams illustrating a sensing circuit according to a second example embodiment of the present disclosure;

FIG. 11 is a diagram illustrating a sensing circuit according to a third example embodiment of the present disclosure;

FIG. 12 is a diagram illustrating a sensing circuit according to a fourth example embodiment of the present disclosure;

FIG. 13 is a diagram illustrating a sensing circuit according to a fifth example embodiment of the present disclosure; and

FIG. 14 is a diagram illustrating a sensing circuit according to a sixth example embodiment of the present disclosure.

### DETAILED DESCRIPTION

Advantages and features of the present specification and methods of achieving them will become apparent with reference to example embodiments, which are described below in detail, in conjunction with the accompanying drawings. However, the present specification is not limited to the example embodiments to be described below and may be implemented in different forms, and the embodiments are only provided to more completely disclose the present disclosure and more completely convey the scope of the present disclosure to those skilled in the art. The protected scope of the present disclosure may be defined by the disclosed claims and their equivalents.

Since the shapes, sizes, proportions, angles, numbers, and the like disclosed in the drawings for describing the embodiments of the present disclosure are only examples, the present disclosure is not limited to the illustrated items. The same reference numerals indicate the same components throughout the specification unless otherwise specified. Further, in describing the present disclosure, where a detailed description of related known technology may unnecessarily obscure features or aspects of the present disclosure, the detailed description thereof may be omitted.

Where terms like ‘including,’ ‘having,’ and ‘consisting,’ are used in the present specification, other parts may be added unless a more limiting term like ‘only’ is used. A case in which a component is expressed in a singular form includes a plural form, and vice versa, unless explicitly stated otherwise.

In interpreting the components, it should be understood that an error range is included even where there is no separate explicit description.

In the case of a description of a positional relationship, for example, where the positional relationship of two parts is described as ‘on,’ ‘at an upper portion,’ ‘at a lower portion,’ ‘next to, and the like, one or more other parts may be located between the two parts unless a more limiting term like ‘immediately’ or ‘directly’ is used.

Although first, second, and the like may be used to describe various components, these components are not limited by these terms. These terms are only used to refer to one component separately from another. Accordingly, a first component may also be a second component, and vice versa, within the technical spirit of the present disclosure.

The same reference numerals may refer to substantially the same elements throughout the present disclosure unless otherwise specified.

The following example embodiments can be partially or entirely bonded to or combined with each other and can be linked and operated in technically various ways. The embodiments can be carried out independently of or in association with each other.

Hereinafter, various example embodiments of the present disclosure will be described in detail with reference to the accompanying drawings.

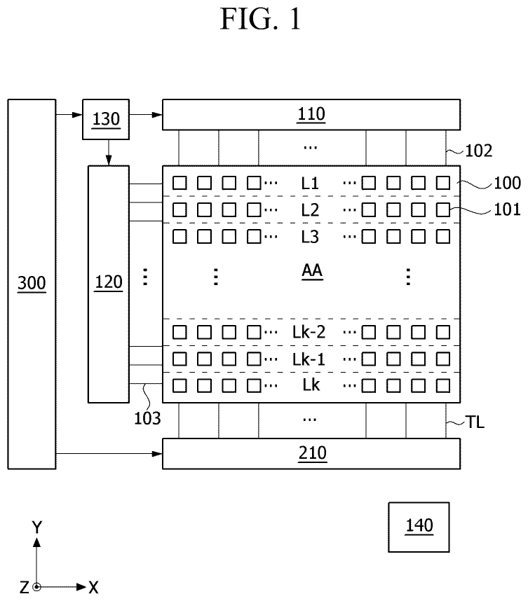

FIG. 1 is a block diagram illustrating a display device according to one or more example embodiments of the present disclosure.

As shown in FIG. 1, a display device according to an example embodiment of the present disclosure includes a display panel 100, a display panel driving circuit that writes video data to pixels of the display panel 100, and a power supply 140. The display panel driving circuit may further include a touch sensor driving circuit 210.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The display area AA includes a plurality of pixel lines L1 to Lk. Each of the pixel lines L1 to Lk includes one line of pixels arranged along the line direction (X-axis direction) in the pixel array of the display panel 100. Those pixels arranged in one pixel line share the same gate lines 103. The sub-pixels arranged in the column direction (Y-axis direction) along the data line direction share the same data line 102. One horizontal period is a time obtained by dividing one frame period by the total number of pixel lines L1 to Lk.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 140 receives an input voltage applied from the host system 300 and outputs a voltage for driving the pixels 101 of the display panel 100 and the display panel driving circuit. To this end, the power supply 140 may include a direct current to direct current converter (DC-DC converter). The DC-DC converter may include a charge pump, a regulator, a buck converter, a boost converter, and the like. The power supply 140 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter and the gate driver 120. Voltages such as pixel driving voltage, cathode voltage, and reference voltage may be supplied to the pixels 101 through the power lines commonly connected to the pixels 101.

The power supply 140 may further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages.

The display panel driving circuit writes pixel data of the input image to the pixels 101 of the display panel 100 under the control of the timing controller 130. The display panel driving circuit includes a data driver 110 and a gate driver 120.

The data driver 110 and the touch sensor driving circuit 210may be integrated into one drive IC or into separate drive ICs. In a mobile terminal or a wearable terminal, components such as the timing controller 130, the power supply 140, the data driver 110, and the touch sensor driving circuit 210 may be integrated into a one drive IC.

The data driver 110 receives pixel data of the input image as a digital data from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas outside the display area AA in the display panel 100 or at least a part thereof may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals.

The touch sensor driving circuit 210 is connected to touch wires TL. The touch wires TL are connected to a cathode electrode divided into regions of a plurality of touch units (or touch circuits). The cathode electrode may be formed integrally. In the embodiment, an in-cell touch technique that uses the cathode electrode without configuring separate touch electrodes may be implemented.

The timing controller 130 receives digital video data of an input image and a timing signal synchronized with this data from the host system 300. The timing signal may include a vertical synchronization signal (Vsync), a horizontal synchronization signal (Hsync), and a data enable signal (DE). Since the vertical period and horizontal period may be known by counting the data enable signal (DE), the vertical synchronization signal (Vsync) and the horizontal synchronization signal (Hsync) may be omitted. The horizontal synchronization signal (Hsync) and the data enable signal (DE) have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals received from the host system 300. The timing controller 130 may synchronize the data driver 110 and the gate driver 120 by controlling the operation timing of the display panel driving circuit.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

A host system 300 may process a user's command received through a touch input in response to touch data input from the touch sensor driving circuit 210.

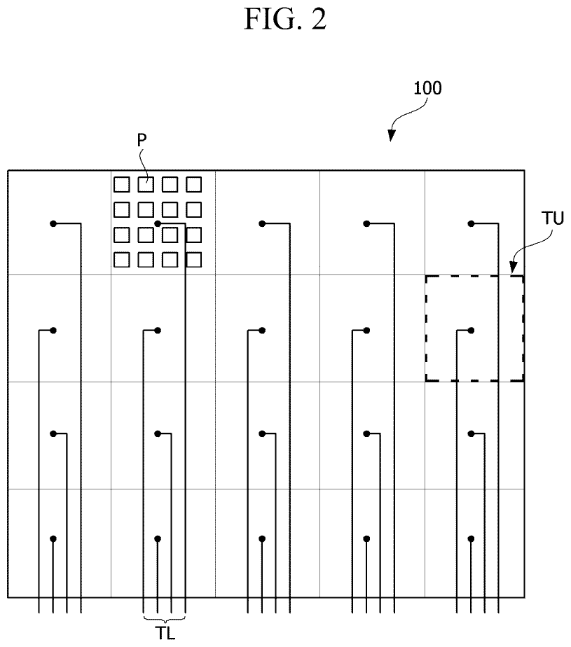

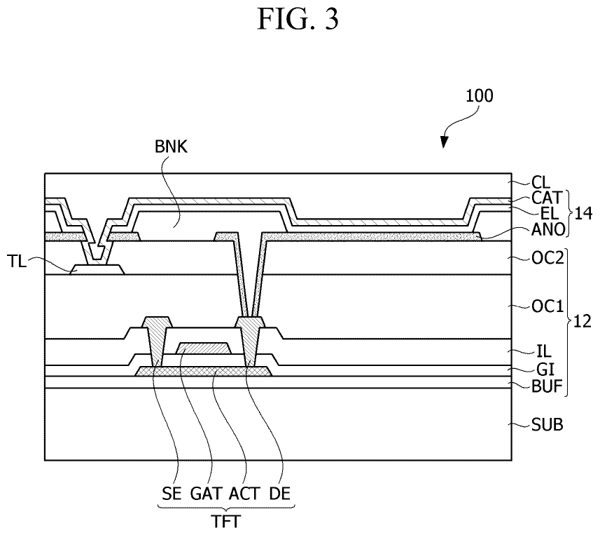

FIG. 2 is a diagram illustrating a touch unit (or touch circuit) according to one or more example embodiments of the present disclosure, and FIG. 3 is a diagram illustrating an example cross section of a display panel corresponding to the touch unit illustrated in FIG. 2.

As shown in FIG. 2, in one or more example embodiments of the present disclosure, a cathode electrode CAT may be divided into multiple regions without separate touch electrodes, and one region may be defined as a touch unit (or touch circuit) TU.

The touch wire TL may be connected to the cathode electrode CAT in the region corresponding to the touch unit TU. The cathode electrode CAT may be divided into a plurality of touch units by the touch wires TL. In the region corresponding to one touch unit, multiple subpixels P may be provided.

The touch wires TL connected to the touch units TU may be connected to the touch sensor driving circuit.

As shown in FIG. 3, the display panel 100 according to an example embodiment of the present disclosure may include a substrate SUB, a circuit layer 12, a touch wire TL, a light-emitting element layer 14, and a cover layer CL.

The substrate SUB may be made of plastic having flexibility, but the present disclosure is not limited thereto. For example, the substrate SUB may be a glass substrate.

The circuit layer 12 may be formed on the substrate SUB. A thin-film transistor TFT including an active layer ACT, a gate electrode GAT, a source electrode SE, and a drain electrode DE may be formed in the circuit layer 12. The circuit layer 12 may include a buffer layer BUF formed on the substrate SUB, the active layer ACT formed on the buffer layer BUF, a gate insulating layer GI that covers the buffer layer BUF on which the active layer ACT is formed, the gate electrode GAT formed on the gate insulating layer GI, an interlayer insulating layer IL that covers the gate insulating layer GI on which the gate electrode GAT is formed, the source electrode SE and the drain electrode DE formed on the interlayer insulating layer IL, a first planarization layer OC1 that covers the interlayer insulating layer IL on which the source electrode SE and the drain electrode DE are formed, and a second planarization layer OC2 formed on the first planarization layer OC1.

The touch wire TL may be formed in the circuit layer 12. The touch wire TL may be formed on the first planarization layer OC1 of the circuit layer 12 and connected to the cathode electrode CAT.

The touch wire TL may be formed in the circuit layer 12 and formed at a position not overlapping the active layer ACT, the source electrode SE, the drain electrode DE, and the gate electrode GAT in the circuit layer.

The light-emitting element layer 14 may be formed on the circuit layer 12. The light-emitting element layer 14 may include an anode electrode ANO formed on the second planarization layer OC2 of the circuit layer 12, a bank layer BNK formed on the anode electrode ANO, a light-emitting layer EL formed on the anode electrode ANO and the bank layer BNK, and the cathode electrode CAT formed on the light-emitting layer EL.

The cover layer CL may be formed on the light-emitting element layer 14.

A cross-sectional structure of the display panel described herein is merely an example, and the present disclosure is not limited thereto.

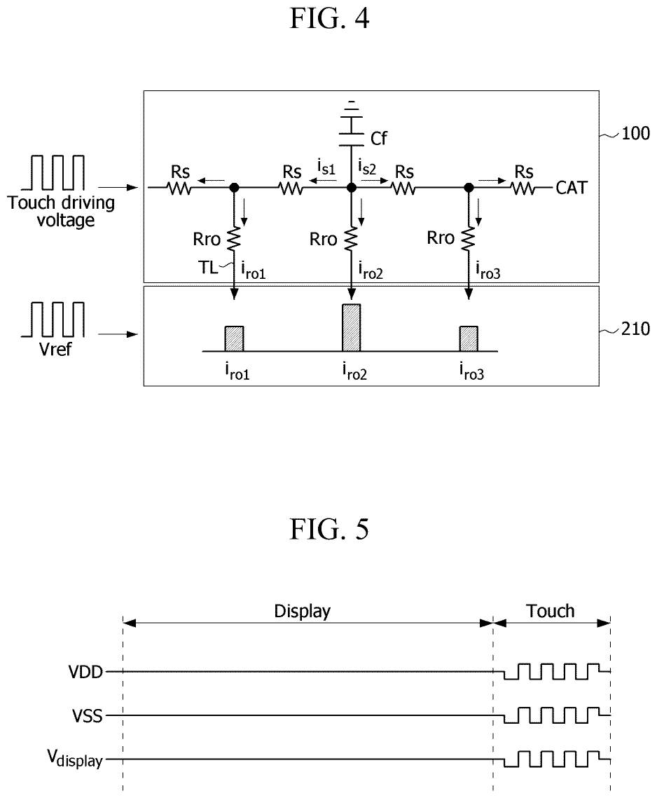

FIGS. 4 and 5 are diagrams illustrating a sensing principle according to one or more example embodiments of the present disclosure.

As shown in FIG. 4, the cathode electrode according to one or more example embodiments of the present disclosure may be formed integrally and divided into regions of a plurality of touch units (or touch circuits) by touch wires. The cathode electrode may have surface resistance Rs, and the touch wire may have internal resistance Rro.

When a touch is performed on the display panel 100, an object capacitor Cf may be formed between an object (for example, a finger) and the cathode electrode, touch currents iₛ₁ and iₛ₂ formed in the object capacitor Cf may be output to multiple touch wires TL through the surface resistance of the cathode electrode, and touch currents iᵣₒ₁, iᵣₒ₂, and iᵣₒ₃ flowing through the internal resistance Rro of the multiple touch wires TL may be output to a sensing circuit of the touch sensor driving circuit 210.

In this case, when a display mode is driven, a high potential voltage VDD, a low potential voltage VSS, and a driving voltage V_{display} such as a reference voltage Vref are applied at a certain voltage level to the display panel, and when a touch sensing mode is driven, the high potential voltage VDD, the low potential voltage VSS, and the driving voltage V_{display} may be modulated using pulse width modulation (PWM) and applied as in FIG. 5.

In this case, values of the touch currents iᵣₒ₁, iᵣₒ₂, and iᵣₒ₃ flowing in the multiple touch wires TL may be different by the surface resistance Rs of the cathode electrode CAT depending on a touch position.

Since the surface resistance Rs of the cathode electrode is greater as a distance from the touch position is farther, the value of the touch current flowing in the touch wire far away from the touch position may be gradually smaller. As a result, the value of a second touch current iᵣₒ₂ flowing in the touch wire closer to the touch position may be greater than the values of a first touch current iᵣₒ₁ and a third touch current iᵣₒ₃ flowing in adjacent touch wires. The sensing circuit may sense touch currents flowing in multiple touch wires, and may detect a touch position through the intensity of the touch current. For example, position coordinates of multiple touch wires may be set in advance, and the touch position may be discriminated through the position coordinates of the touch wire with large current intensity among the multiple touch wires.

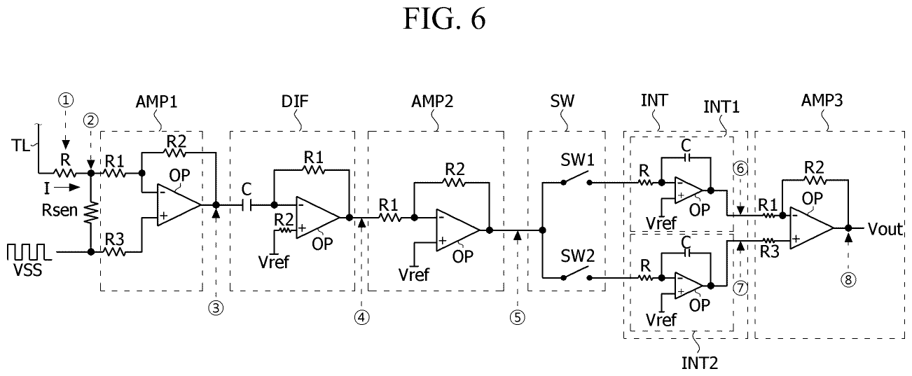

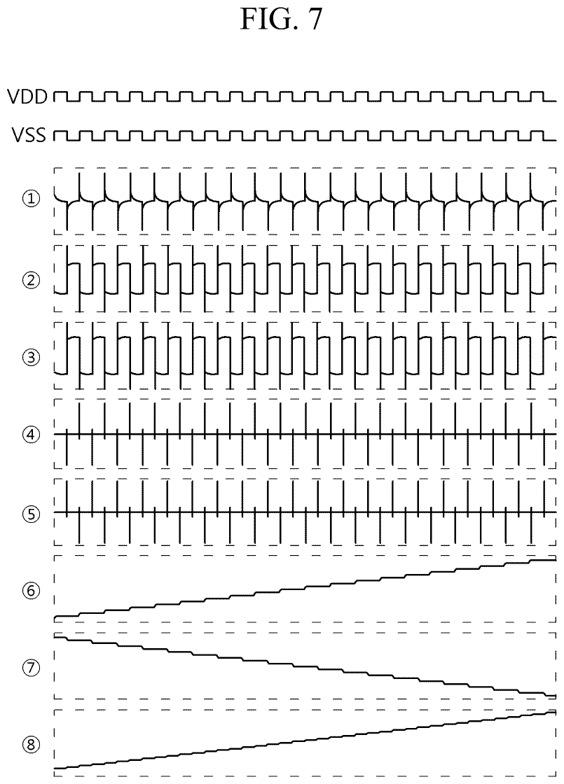

FIG. 6 is a diagram illustrating a sensing circuit according to a first example embodiment of the present disclosure, and FIG. 7 is a diagram illustrating input and output voltages of the sensing circuit illustrated in FIG. 6.

Here, the sensing circuit is a single sensing circuit that performs sensing using one touch wire.

As shown in FIG. 6, a sensing circuit according to a first embodiment of the present disclosure may include a sensing resistor Rsen, a first amplifier AMP1, a differentiator DIF, a second amplifier AMP2, a switch SW, an integrator INT, and a third amplifier AMP3.

The sensing resistor Rsen is connected between a touch wire TL connected to a touch unit and a power line to which the low potential voltage VSS is applied to sense a current change for the region of the touch unit.

Here, the low potential voltage VSS and the high potential voltage VDD may be modulated voltages as in FIG. 7. A current flowing in the touch wire TL is as shown by \hat{1} in FIG. 7.

The first amplifier AMP1 may amplify and output a voltage difference between both ends of the sensing resistor Rsen. The first amplifier AMP1 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The first resistor R1 is connected between the inverting terminal (−) of the operational amplifier OP and one end of the sensing resistor Rsen. The second resistor R2 is connected between an output end and the inverting terminal (−) of the operational amplifier OP. The third resistor R3 is connected between the non-inverting terminal (+) of the operational amplifier OP and the other end of the sensing resistor Rsen.

Here, an input voltage and an output voltage of the first amplifier AMP1 are as shown by \hat{2} and \hat{3} in FIG. 7, respectively.

The differentiator DIF may differentiate an amplified signal from the first amplifier AMP1 and may output an amount of change in voltage. The differentiator DIF may differentiate the amplified signal from the first amplifier AMP1 and may remove a direct-current component of the signal. The differentiator DIF may include an operational amplifier OP, a capacitor C, a first resistor R1, and a second resistor R2. The capacitor C is connected to an inverting terminal (−) of the operational amplifier OP, and the second resistor R2 is connected to a non-inverting terminal (+) of the operational amplifier OP. The capacitor C is connected between an output end of the first amplifier AMP1 and the inverting terminal (−) of the operational amplifier OP. The first resistor R1 is connected between the inverting terminal (−) and an output end of the operational amplifier OP. The second resistor R2 is connected between the non-inverting terminal (+) of the operational amplifier OP and a power line to which the reference voltage Vref is applied.

Here, an output voltage of the differentiator DIF is as shown by \hat{4} in FIG. 7.

The second amplifier AMP2 may amplify and output a difference between a signal output from the differentiator DIF and the reference voltage Vref. The second amplifier AMP2 may include an operational amplifier OP, a first resistor R1, and a second resistor R2. The first resistor R1 is connected to an inverting terminal (−) of the operational amplifier OP, and the reference voltage Vref is applied to a non-inverting terminal (+) of the operational amplifier OP. The first resistor R1 is connected between an output end of the differentiator DIF and the inverting terminal (−) of the operational amplifier OP. The second resistor R2 is connected between the inverting terminal (−) and an output end of the operational amplifier OP.

Here, an output voltage of the second amplifier AMP2 is as shown by \hat{5} in FIG. 7.

The switch SW may include a first switch SW1 and a second switch SW2 to separate a positive signal (or a positive voltage) and a negative signal (or a negative voltage) of a signal output from the second amplifier AMP2. The first switch SW1 is turned on in response to a first control signal and separates and transfers the positive signal of the signal output from the second amplifier AMP2. The second switch SW2 is turned on in response to a second control signal and separates and transfers the negative signal of the signal output from the second amplifier AMP2. Here, the second control signal may be an inverted signal of the first control signal. That is, the first switch SW1 and the second switch SW2 may be turned on or off at different points of time.

The integrator INT may include a first integrator INT1 and a second integrator INT2. The first integrator INT1 integrates and outputs the positive signal transferred via the first switch SW1. The second integrator INT2 integrates and outputs the negative signal transferred via the second switch SW2.

The first integrator INT1 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between the first switch SW1 and the inverting terminal (−) of the operational amplifier OP. The capacitor C is connected between the inverting terminal (−) and an output end of the operational amplifier OP.

Here, an output voltage of the first integrator INT1 is as shown by \hat{6} in FIG. 7.

The second integrator INT2 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between the second switch SW2 and the inverting terminal (−) of the operational amplifier OP. The capacitor C is connected between the inverting terminal (−) and an output end of the operational amplifier OP.

Here, an output voltage of the second integrator INT2 is as shown by \hat{7} in FIG. 7.

The third amplifier AMP3 may amplify a difference between a signal output from the first integrator INT1 and a signal output from the second integrator INT2 and may output an amplified voltage Vout. The third amplifier AMP3 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The first resistor R1 is connected between the inverting terminal (−) of the operational amplifier OP and an output end of the first integrator INT1. The second resistor R2 is connected to an output end and the inverting terminal (−) of the operational amplifier OP. The third resistor R3 is connected between the non-inverting terminal (+) of the operational amplifier OP and an output end of the second integrator INT2.

Here, an output voltage of the third amplifier AMP3 is as shown by \hat{8} in FIG. 7.

An ADC may be further provided at an output end of the third amplifier AMP3. The ADC may convert an analog signal output from the third amplifier AMP3 into digital data.

In this way, the differentiator is used to remove a direct-current component from a voltage difference between both ends of the sensing resistor. When integration is performed with no differentiator, a direct-current component is present in the integrator and an output of the integrator reaches a saturation state. To prevent such a problem, the differentiator is used, the positive voltage and the negative voltage of the signal output from the differentiator are separated and integrated, and a difference between the integrated voltages is sensed.

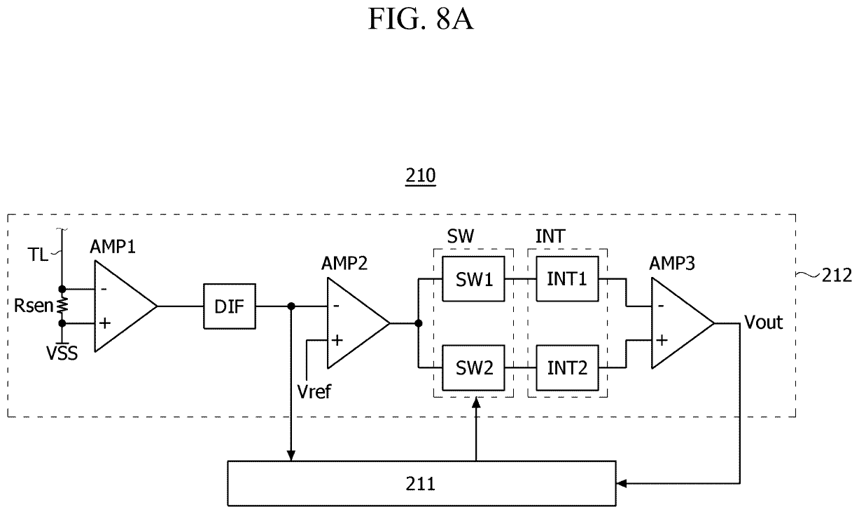

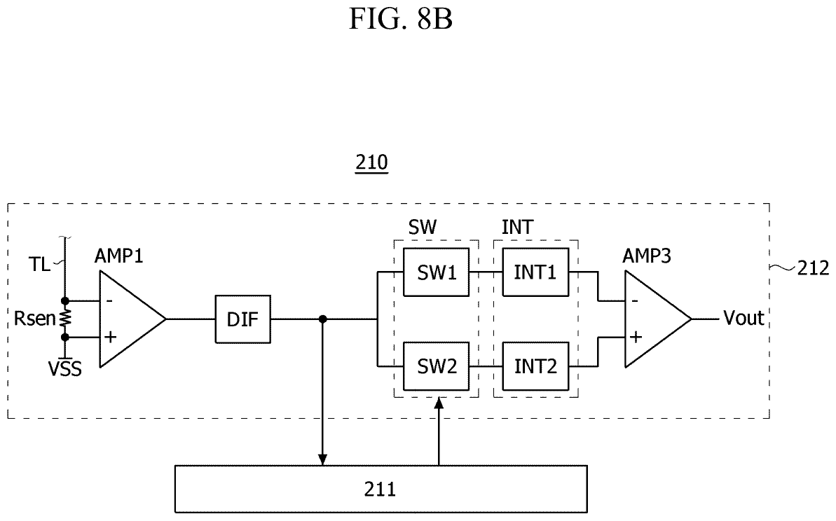

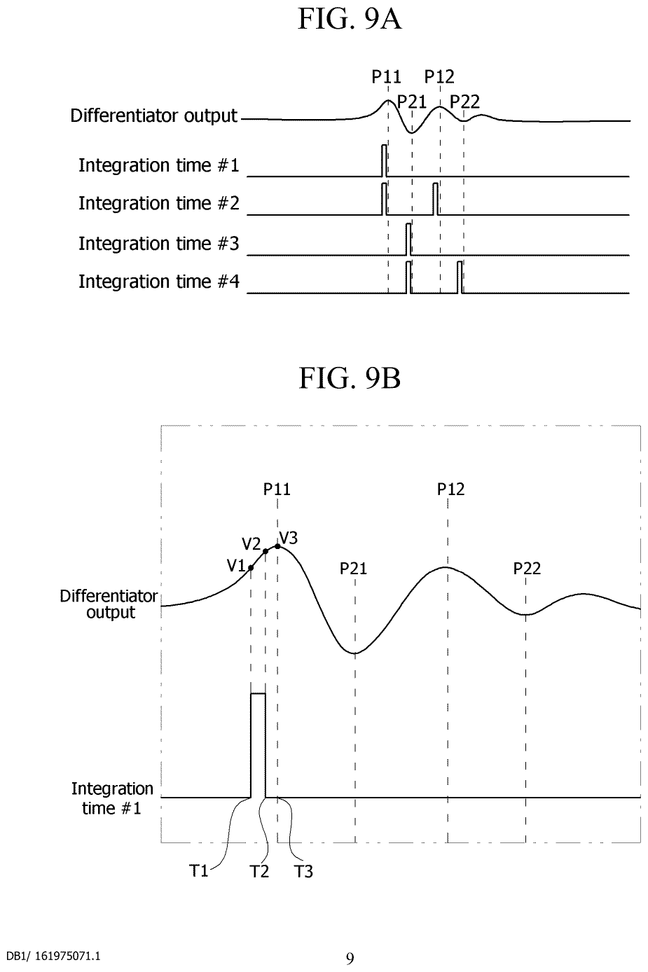

FIGS. 8A and 8B are diagrams illustrating a sensing principle according to one or more example embodiments of the present disclosure, and FIGS. 9A and 9B are diagrams illustrating an integration time setting principle according to one or more example embodiments of the present disclosure.

As shown in FIG. 8A, the touch sensor driving circuit 210 according to an example embodiment of the present disclosure includes a driving circuit 211 and a sensing circuit 212, and the driving circuit 211 may control the sensing circuit 212.

The driving circuit 211 may generate a control signal for controlling the switch SW on the basis of the signal output from the differentiator DIF in the sensing circuit 212 and may output the generated control signal.

In the embodiment, an integration time of the integrator INT will be set by controlling the switch SW. The integration time may be set in a transition section of a touch driving signal and may be set based on a maximum point as a positive peak value or a minimum point as a negative peak value. Here, the maximum point and the minimum point may be a point measured in advance by an experiment.

For example, as in FIG. 9A, the signal output from the differentiator DIF may have two maximum points, i.e., (1-1)th and (1-2)th maximum points P11 and P12 and two minimum points, i.e., (2-1)th and (2-2)th minimum points P21 and P22. That is, an integration time #1 may be set to a time range determined in advance before the (1-1)th maximum point P11. An integration time #2 may be set to a time range determined in advance before the (1-1)th maximum point P11 and to a time range determined in advance before the (1-2)th maximum point P12.

An integration time #3 may be set to a time range determined in advance before the (2-1)th minimum point P21. An integration time #4 may be set to a time range determined in advance before the (2-1)th minimum point P21 and to a time range determined in advance before the (2-2)th minimum point P22.

The driving circuit 211 may generate a control signal for turning on the switch for the integration time #1 set in advance using the signal output from the differentiator in the sensing circuit 212.

For example, when the integration time #1 is set to a range of T1 to T2 as in FIG. 9B, the driving circuit 211 may turn on the switch until a voltage level of an output signal of the differentiator reaches a voltage V2 corresponding to time T2 from a voltage V1 corresponding to time T1.

When the voltage level of the output signal of the differentiator is a voltage V3, it may be the maximum point P11.

In the embodiment, the integration time may be set such that all maximum points and minimum points of the signal output from the differentiator DIF, that is, the voltage change amount are not included. This is because the positive value and the negative value of the voltage change amount may cancel each other when all maximum points and minimum points are included. Here, with a voltage change amount of “0” as a reference, a value greater than “0” is a positive value and a value smaller than “0” is a negative value.

Accordingly, the driving circuit 211 may generate a control signal for turning on the switch for the integration time set in advance on the basis of the signal output from the differentiator DIF.

A sensing circuit of FIG. 8B has a modified structure with respect to the sensing circuit illustrated in FIG. 8A and has the same configurations and functions as the sensing circuit of FIG. 8A, except that the second amplifier AMP2 is excluded from the configuration of the sensing circuit of FIG. 8A.

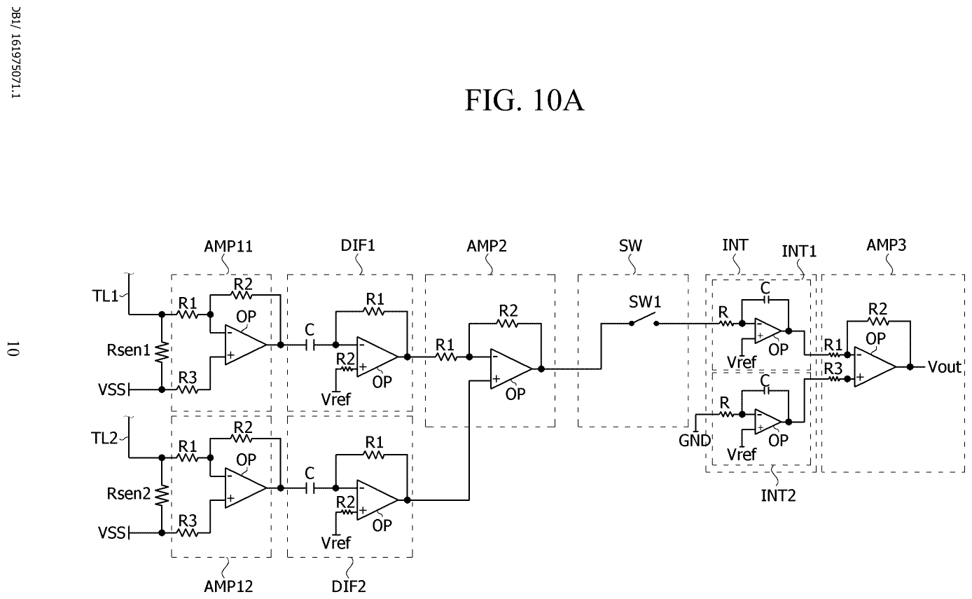

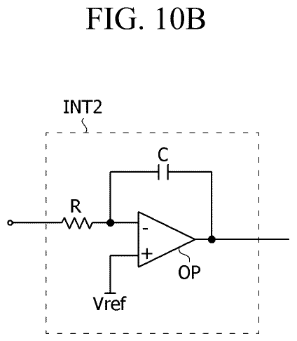

FIGS. 10A and 10B are diagrams illustrating a sensing circuit according to a second example embodiment of the present disclosure.

Here, the sensing circuit is a differential sensing circuit that performs sensing using two touch wire.

As shown in FIG. 10A, a sensing circuit according to a second embodiment of the present disclosure may include a first sensing resistor Rsen1, a second sensing resistor Rsen2, an (1-1)th amplifier AMP11, a (1-2)th amplifier AMP12, a first differentiator DIF1, a second differentiator DIF2, a second amplifier AMP2, a switch SW, an (1-1)th integrator INT11, a (1-2)th integrator INT12, and a third amplifier AMP3.

The first sensing resistor Rsen1 is connected between a first touch wire TL1 connected to a touch unit and a power line to which a low potential voltage VSS is applied. The second sensing resistor Rsen2 is connected between a second touch wire TL2 connected to a touch unit and the power line to which the low potential voltage VSS is applied.

The (1-1)th amplifier AMP11 may amplify and output a voltage difference between both ends of the first sensing resistor Rsen1. The (1-1)th amplifier AMP11 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The first resistor R1 is connected between the inverting terminal (−) of the operational amplifier OP and one end of the first sensing resistor Rsen1. The second resistor R2 is connected between an output end and the inverting terminal (−) of the operational amplifier OP. The third resistor R3 is connected between the non-inverting terminal (+) of the operational amplifier OP and the other end of the first sensing resistor Rsen1.

The (1-2)th amplifier AMP12 may amplify and output a voltage difference between both ends of the second sensing resistor Rsen2. The (1-2)th amplifier AMP12 may include an operational amplifier OP, a first resistor, a second resistor, and a third resistor. The first resistor R1 is connected to an inverting terminal (−) of the operational amplifier OP, and the second resistor R2 is connected to a non-inverting terminal (+) of the operational amplifier OP. The first resistor R1 is connected between the inverting terminal (−) of the operational amplifier OP and one end of the second sensing resistor Rsen2. The second resistor R2 is connected between an output end and the inverting terminal (−) of the operational amplifier OP. The third resistor R3 is connected between the non-inverting terminal (+) of the operational amplifier OP and the other end of the second sensing resistor Rsen2.

The first differentiator DIF1 may differentiate an amplified signal from the (1-1)th amplifier AMP11 and may output a voltage change amount. The first differentiator DIF1 may include an operational amplifier OP, a capacitor C, a first resistor R1, and a second resistor R2. The capacitor C is connected to an inverting terminal (−) of the operational amplifier OP, and the second resistor R2 is connected to a non-inverting terminal (+) of the operational amplifier OP. The capacitor C is connected between an output end of the (1-1)th amplifier AMP11 and the inverting terminal (−) of the operational amplifier OP. The first resistor R1 is connected between the inverting terminal (−) and an output end of the operational amplifier OP. The second resistor R2 is connected between the non-inverting terminal (+) of the operational amplifier OP and a power line to which a reference voltage Vref is applied.

The second differentiator DIF2 may differentiate an amplified signal from the (1-2)th amplifier AMP12 and may output a voltage change amount. The second differentiator DIF2 may include an operational amplifier OP, a capacitor C, a first resistor R1, and a second resistor R2. The capacitor C is connected to an inverting terminal (−) of the operational amplifier OP, and the second resistor R2 is connected to a non-inverting terminal (+) of the operational amplifier OP. The capacitor C is connected between an output end of the (1-2)th amplifier AMP12 and the inverting terminal (−) of the operational amplifier OP. The first resistor R1 is connected between the inverting terminal (−) and an output end of the operational amplifier OP. The second resistor R2 is connected between the non-inverting terminal (+) of the operational amplifier OP and the power line to which the reference voltage Vref is applied.

The second amplifier AMP2 may amplify and output a difference between a signal output from the first differentiator DIF1 and a signal output from the second differentiator DIF2. The second amplifier AMP2 may include an operational amplifier OP, a first resistor R1, and a second resistor R2. The first resistor R1 is connected to an inverting terminal (−) of the operational amplifier OP, and an output end of the second differentiator DIF2 is connected to a non-inverting terminal (+) of the operational amplifier OP. The first resistor R1 is connected between an output end of the first differentiator DIF1 and the inverting terminal (−) of the operational amplifier OP. The second resistor R2 is connected between the inverting terminal (−) and an output end of the operational amplifier OP.

The switch SW may separate and output a positive signal or a negative signal of a signal output from the second amplifier AMP2. The switch SW is turned on in response to a control signal and separates and transfer the positive signal or the negative signal of the signal output from the second amplifier AMP2.

The first integrator INT1 may integrate and output the positive signal or the negative signal transferred via the switch SW. The first integrator INT1 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between the switch SW and the inverting terminal (−) of the operational amplifier OP. The capacitor C is connected between the inverting terminal (−) and an output end of the operational amplifier OP.

The second integrator INT2 may integrate and output a ground voltage or a voltage in a floating state. The second integrator INT2 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. One end of the resistor R may be connected to the inverting terminal (−) of the operational amplifier OP, and the other end of the resistor R may be connected to a ground GND. The capacitor C is connected between the inverting terminal (−) and an output end of the operational amplifier OP.

Here, although the ground GND is connected to the resistor R connected to the inverting terminal (−) of the operational amplifier OP in the second integrator INT2, the resistor R may not be connected to any place and may be in a floating state as in FIG. 10B.

In the embodiment, to remove common noise of the two touch wires TL1 and TL2, the inverting terminal (−) of the second integrator INT2 will be connected to the ground GND or brought into a floating state.

The third amplifier AMP3 may amplify a difference between a signal output from the first integrator INT1 and a signal output from the second integrator INT2 and may output an amplified voltage Vout. The third amplifier AMP3 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The first resistor R1 is connected between the inverting terminal (−) of the operational amplifier OP and an output end of the first integrator INT1. The second resistor R2 is connected between an output end and the inverting terminal (−) of the operational amplifier OP. The third resistor R3 is connected between the non-inverting terminal (+) of the operational amplifier OP and an output end of the second integrator INT2.

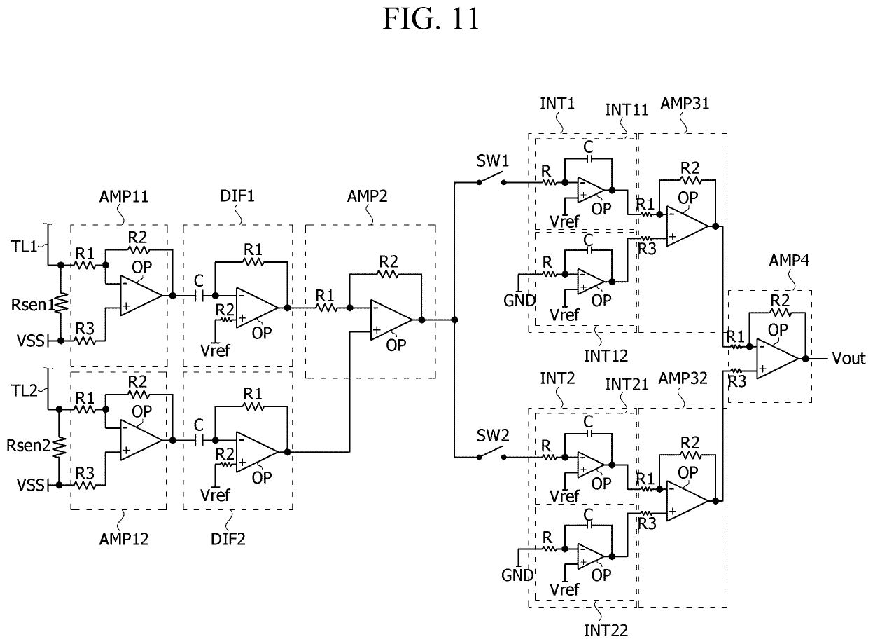

FIG. 11 is a diagram illustrating a sensing circuit according to a third example embodiment of the present disclosure.

Here, the sensing circuit is a differential sensing circuit that performs sensing using two touch wire.

As shown in FIG. 11, a sensing circuit according to a third embodiment of the present disclosure may include a first sensing resistor Rsen1, a second sensing resistor Rsen2, an (1-1)th amplifier AMP11, a (1-2)th amplifier AMP12, a first differentiator DIF1, a second differentiator DIF2, a second amplifier AMP2, a first switch SW1, an (1-1)th integrator INT11, a (1-2)th integrator INT12, a second switch SW2, a (2-1)th integrator INT21, a (2-2)th integrator INT22, a (3-1)th amplifier AMP31, a (3-2)th amplifier AMP32, and a fourth amplifier AMP4.

The sensing circuit according to the third embodiment has a modified structure with respect to the sensing circuit according to the second embodiment in FIG. 9A, and has a difference from the sensing circuit according to the second embodiment in terms of a process of processing the signal output from the second amplifier AMP2. Hereinafter, only the process of processing the signal output from the second amplifier AMP2 will be described.

The first switch SW1 is turned on in response to a first control signal and separates and transfers a positive signal of the signal output from the second amplifier AMP2. The second switch SW2 is turned on in response to a second control signal and separates and transfers a negative signal of the signal output from the second amplifier AMP2.

The (1-1)th integrator INT11 integrates and outputs the positive signal or the negative signal transferred via the first switch SW1. The (1-1)th integrator INT11 includes an operational amplifier OP, a resistor R, and a capacitor C. The resistor R is connected to an inverting terminal (−) of the operational amplifier OP, and a reference voltage Vref is applied to a non-inverting terminal (+) of the operational amplifier OP. The resistor R is connected between the switch SW and the inverting terminal (−) of the operational amplifier OP. The capacitor C is connected between the inverting terminal (−) and an output end of the operational amplifier OP.

The (1-2)th integrator INT12 integrates and outputs a ground voltage or a voltage in a floating state. The (1-2)th integrator INT12 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. One end of the resistor R is connected to the inverting terminal (−) of the operational amplifier OP and the other end of the resistor R is connected to the ground GND. The capacitor C is connected between the inverting terminal (−) and an output end of the operational amplifier OP.

In this case, one end of the resistor R may be connected to the inverting terminal (−) of the operational amplifier OP, and the other end of the resistor R may not be connected to the ground GND and may not be connected to any place to be brought into a floating state.

The (2-1)th integrator INT21 integrates and outputs the positive signal of the signal transferred via the second switch SW2. The (2-1)th integrator INT21 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between the second switch SW2 and the inverting terminal (−) of the operational amplifier OP. The capacitor C is connected between the inverting terminal (−) and an output end of the operational amplifier OP.

The (2-2)th integrator INT22 integrates and outputs a ground voltage or a voltage in a floating state. The (2-2)th integrator INT22 includes an operational amplifier OP, a resistor R, and a capacitor C. The resistor R is connected to an inverting terminal (−) of the operational amplifier OP, and the reference voltage Vref is connected to a non-inverting terminal (+) of the operational amplifier OP. One end of the resistor R is connected to the inverting terminal (−) of the operational amplifier OP and the other end of the resistor R is connected to the ground GND. The capacitor C is connected between the inverting terminal (−) and an output end of the operational amplifier OP.

In this case, one end of the resistor R may be connected to the inverting terminal (−) of the operational amplifier OP and the other end of the resistor R may not be connected to the ground GND and may not be connected to any place to be brought into a floating state.

The (3-1)th amplifier AMP31 may amplify and output a difference between a signal output from the (1-1)th integrator INT11 and a signal output from the (1-2)th integrator INT12. The (3-1)th amplifier AMP31 may include an operational amplifier OP, a first resistor R1, a second resistor R2, and a third resistor R3. An inverting terminal (−) of the operational amplifier OP is connected to an output end of the (1-1)th integrator INT11, and a non-inverting terminal (+) of the operational amplifier OP is connected to an output end of the (1-2)th integrator INT12.

The (3-2)th amplifier AMP32 may amplify and output a difference between a signal output from the (2-1)th integrator INT21 and a signal output from the (2-2)th integrator INT22. The (3-2)th amplifier AMP32 may include an operational amplifier OP, a first resistor R1, a second resistor R2, and a third resistor R3. An inverting terminal (−) of the operational amplifier OP is connected to an output end of the (2-1)th integrator INT21, and a non-inverting terminal (+) of the operational amplifier OP is connected to an output end of the (2-2)th integrator INT22.

The fourth amplifier AMP4 may amplify a difference between a signal output from the (3-1)th amplifier AMP31 and a signal output from the (3-2)th amplifier AMP32 and may output an amplified voltage Vout. The fourth amplifier AMP4 may include an operational amplifier OP, a first resistor R1, a second resistor R2, and a third resistor R3. An inverting terminal (−) of the operational amplifier OP is connected to an output end of the (3-1)th amplifier AMP31, a non-inverting terminal (+) of the operational amplifier OP is connected to an output end of the (3-2)th amplifier AMP32. The first resistor R1 is connected between the inverting terminal (−) of the operational amplifier OP and the output end of the (3-1)th amplifier AMP31. The second resistor R2 is connected between an output end and the inverting terminal (−) of the operational amplifier OP. The third resistor R3 is connected between the non-inverting terminal (+) of the operational amplifier OP and an output end of the (3-2)th amplifier AMP32.

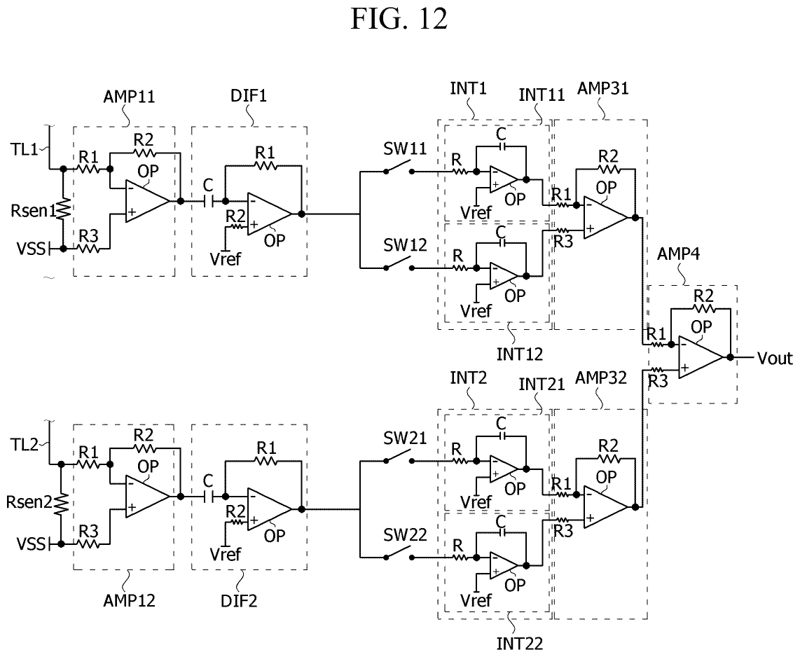

FIG. 12 is a diagram illustrating a sensing circuit according to a fourth example embodiment of the present disclosure.

Here, the sensing circuit is a differential sensing circuit that performs sensing using two touch wires.

As shown in FIG. 12, a sensing circuit according to a fourth embodiment of the present disclosure may include a first sensing resistor Rsen1, a second sensing resistor Rsen2, an (1-1)th amplifier AMP11, a (1-2)th amplifier AMP12, a first differentiator DIF1, a second differentiator DIF2, an (1-1)th switch SW11, a (1-2)th switch SW12, a (2-1)th switch SW21, a (2-2)th switch SW22, an (1-1)th integrator INT11, a (1-2)th integrator INT12, a (2-1)th integrator INT21, a (2-2)th integrator INT22, a (3-1)th amplifier AMP31, a (3-2)th amplifier AMP32, and a fourth amplifier AMP4.

The sensing circuit according to the fourth embodiment has a modified structure with respect to the sensing circuit according to the third embodiment in FIG. 11, and description will be provided starting with the (1-1)th, (1-2)th, (2-1)th, and (2-2)th switches SW11, SW12, SW21, SW22 having different configurations.

The (1-1)th switch SW11 is turned on in response to a first control signal and separates and transfers a positive signal of a signal output from the first differentiator DIF1. The (1-2)th switch SW12 is turned on in response to a second control signal and separates and transfers a negative signal of the signal output from the first differentiator DIF1.

The (2-1)th switch SW21 is turned on in response to the first control signal and separates and transfers a positive signal of a signal output from the second differentiator DIF2. The (2-2)th switch SW22 is turned on in response to the second control signal and separates and transfers a negative signal of the signal output from the second differentiator DIF2.

The (1-1)th integrator INT11 may integrate and output the positive signal transferred via the (1-1)th switch SW11. The (1-1)th integrator INT11 includes an operational amplifier OP, a resistor R, and a capacitor C. The resistor R is connected to an inverting terminal (−) of the operational amplifier OP, and a reference voltage Vref is applied to a non-inverting terminal (+) of the operational amplifier OP. The resistor R is connected between the (1-1)th switch SW11 and the inverting terminal (−) of the operational amplifier OP. The capacitor C is connected between the inverting terminal (−) and an output end of the operational amplifier OP.

The (1-2)th integrator INT12 may integrate and output the negative signal transferred via the (1-2)th switch SW12. The (1-2)th integrator INT12 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between the (1-2)th switch SW12 and the inverting terminal (−) of the operational amplifier OP. The capacitor C is connected between the inverting terminal (−) and an output end of the operational amplifier OP.

The (2-1)th integrator INT21 may integrate and output the positive signal transferred via the (2-1)th switch SW21. The (2-1)th integrator INT21 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between the (1-1)th switch SW11 and the inverting terminal (−) of the operational amplifier OP. The capacitor C is connected between the inverting terminal (−) and an output end of the operational amplifier OP.

The (2-2)th integrator INT22 may integrate and output the negative signal transferred via the (1-2)th switch SW12. The (2-2)th integrator INT22 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between the (2-2)th switch SW22 and the inverting terminal (−) of the operational amplifier OP. The capacitor C is connected between the inverting terminal (−) and an output end of the operational amplifier OP.

The (3-1)th amplifier AMP31 may amplify and output a difference between a signal output from the (1-1)th integrator INT11 and a signal output from the (1-2)th integrator INT12. The (3-1)th amplifier AMP31 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The second resistor R2 is connected between an output end and the inverting terminal (−) of the operational amplifier OP.

The (3-2)th amplifier AMP32 may amplify and output a difference between a signal output from the (2-1)th integrator INT21 and a signal output from the (2-2)th integrator INT22. The (3-2)th amplifier AMP32 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The second resistor R2 is connected between an output end and the inverting terminal (−) of the operational amplifier OP.

The fourth amplifier AMP4 may amplify a difference between a signal output from the (3-1)th amplifier AMP31 and a signal output from the (3-2)th amplifier AMP32 and may output an amplified voltage Vout. The fourth amplifier AMP4 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The second resistor R2 is connected between an output end and the inverting terminal (−) of the operational amplifier OP.

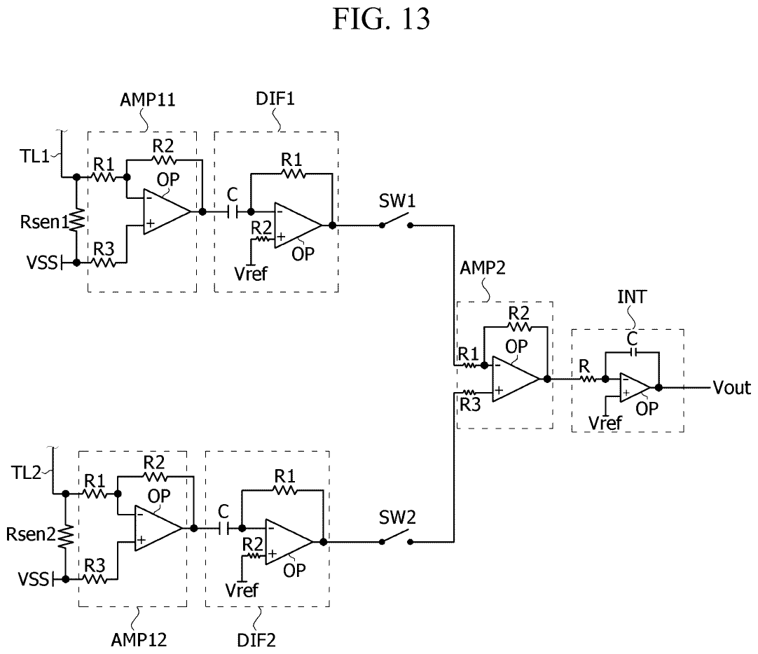

FIG. 13 is a diagram illustrating a sensing circuit according to a fifth example embodiment of the present disclosure.

Here, the sensing circuit is a differential sensing circuit that performs sensing using two touch wires.

As shown in FIG. 13, a sensing circuit according to a fifth embodiment of the present disclosure may include a first sensing resistor Rsen1, a second sensing resistor Rsen2, an (1-1)th amplifier AMP11, a (1-2)th amplifier AMP12, a first differentiator DIF1, a second differentiator DIF2, an (1-1)th switch SW11, a (1-2)th switch SW12, a (2-1)th switch SW21, a (2-2)th switch SW22, a second amplifier AMP2, and an integrator INT.

The sensing circuit according to the fifth embodiment has a modified structure with respect to the sensing circuit according to the third embodiment in FIG. 11, and description will be provided starting with the first switch SW1 and the second switch SW2 having different configurations.

The (1-1)th switch SW11 is turned on in response to a first control signal and separates and transfers a positive signal or a negative signal of a signal output from the first differentiator DIF1.

The (2-1)th switch SW21 is turned on in response to the first control signal and separates and transfers a positive signal or a negative signal of a signal output from the second differentiator DIF2.

The second amplifier AMP2 may amplify and output a difference between the signal transferred via the (1-1)th switch SW11 and the signal transferred via the (2-1)th switch SW21. The second amplifier AMP2 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The first resistor R1 is connected between the inverting terminal (−) of the operational amplifier OP and the first switch SW1. The second resistor R2 is connected between an output end and the inverting terminal (−) of the operational amplifier OP. The third resistor R3 is connected between the non-inverting terminal (+) of the operational amplifier OP and the second switch SW2.

The integrator INT integrates a signal output from the second amplifier AMP2 and outputs an integrated voltage Vout. The integrator INT includes an operational amplifier OP, a resistor R, and a capacitor C. The resistor R is connected to an inverting terminal (−) of the operational amplifier OP, and a reference voltage Vref is applied to a non-inverting terminal (+) of the operational amplifier OP. The resistor R is connected between an output end of the second amplifier AMP2 and the inverting terminal (−) of the operational amplifier OP. The capacitor C is connected between the inverting terminal (−) and an output end of the operational amplifier OP.

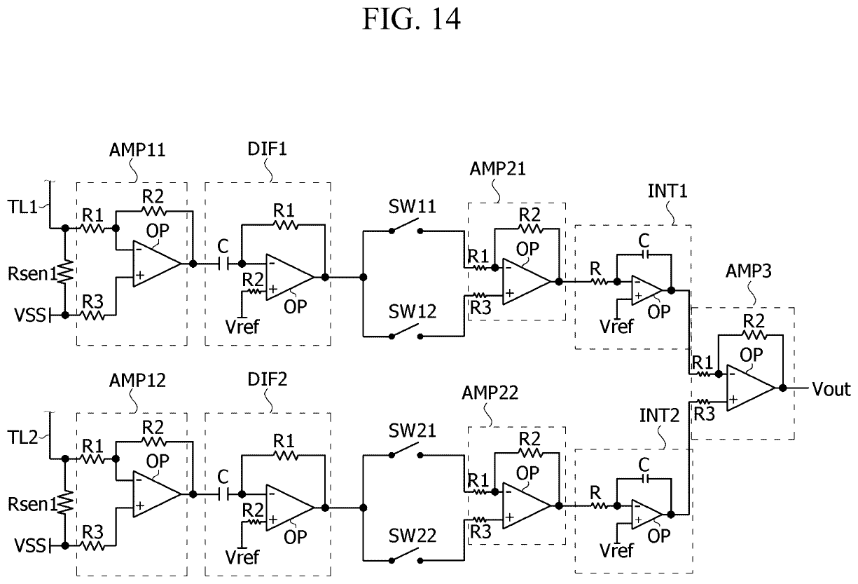

FIG. 14 is a diagram illustrating a sensing circuit according to a sixth example embodiment of the present disclosure.

Here, the sensing circuit is a differential sensing circuit that performs sensing using two touch wires.

As shown in FIG. 14, a sensing circuit according to a sixth embodiment of the present disclosure may include a first sensing resistor Rsen1, a second sensing resistor Rsen2, an (1-1)th amplifier AMP11, a (1-2)th amplifier AMP12, a first differentiator DIF1, a second differentiator DIF2, an (1-1)th switch SW11, a (1-2)th switch SW12, a (2-1)th switch SW21, a (2-2)th switch SW22, a (2-1)th amplifier AMP21, a (2-2)th amplifier AMP22, a first integrator INT1, a second integrator INT2, and a third amplifier AMP3.

The sensing circuit according to the sixth embodiment has a modified structured with respect to the sensing circuit according to the third embodiment in FIG. 11, and description will be provided starting with the (1-1)th, (1-2)th, (2-1)th, and (2-2)th switches SW11, SW12, SW21, and SW22.

The (1-1)th switch SW11 is turned on in response to a first control signal and transfers a positive signal of a signal output from the first differentiator DIF1. The (1-2)th switch SW12 is turned on in response to a second control signal and transfers a negative signal of the signal output from the first differentiator DIF1.

The (2-1)th switch SW21 is turned on in response to the first control signal and transfers a positive signal of a signal output from the second differentiator DIF2. The (2-2)th switch SW22 is turned on in response to the second control signal and transfers a negative signal of the signal output from the second differentiator DIF2.

The (2-1)th amplifier AMP21 may amplify and output a difference between the positive signal transferred via the (1-1)th switch SW11 and the negative signal transferred via the (1-2)th switch SW12. The (2-1)th amplifier AMP21 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The second resistor R2 is connected between the inverting terminal (−) and an output end of the operational amplifier OP.

The (2-2)th amplifier AMP22 may amplify and output a difference between the signal transferred via the (2-1)th switch SW21 and the signal transferred via the (2-2)th switch SW22. The (2-2)th amplifier AMP22 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The second resistor R2 is connected between the inverting terminal (−) and an output end of the operational amplifier OP.

The first integrator INT1 may integrate and output a difference between a signal output from the (2-1)th amplifier AMP21 and a reference voltage. The first integrator INT1 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between an output end of the (2-1)th amplifier AMP21 and the inverting terminal (−) of the operational amplifier OP. The capacitor C is connected between the inverting terminal (−) and an output end of the operational amplifier OP.

The second integrator INT2 may integrate and output a difference between a signal output from the (2-2)th amplifier AMP22 and the reference voltage. The second integrator INT2 includes an operational amplifier OP, a resistor R, and a capacitor C. The resistor R is connected to an inverting terminal (−) of the operational amplifier OP, and the reference voltage Vref is applied to a non-inverting terminal (+) of the operational amplifier OP. The resistor R is connected between an output end of the (2-2)th amplifier AMP22 and the inverting terminal (−) of the operational amplifier OP. The capacitor C is connected between the inverting terminal (−) and an output end of the operational amplifier OP.

The third amplifier AMP3 may amplify a difference between a signal output from the first integrator INT1 and a signal output from the second integrator INT2 and may output an amplified voltage Vout. The fourth amplifier AMP4 may include an operational amplifier OP, a first resistor R1, a second resistor R2, and a third resistor R3. The first resistor R1 is connected to an inverting terminal (−) of the operational amplifier OP, and the third resistor R3 is connected to a non-inverting terminal (+) of the operational amplifier OP. The second resistor R2 is connected between the inverting terminal (−) and an output end of the operational amplifier OP.

Although various example embodiments of the present disclosure have been described in more detail with reference to the accompanying drawings, the present disclosure is not limited thereto and may be embodied in many different forms without departing from the technical concept of the present disclosure. Therefore, the example embodiments disclosed in the present disclosure are provided for illustrative purposes only and are not intended to limit the technical concept of the present disclosure. The scope of the technical concept of the present disclosure is not limited thereto. Therefore, it should be understood that the above-described example embodiments are illustrative in all aspects and do not limit the present disclosure.

What is claimed is:

1. A touch sensor driving circuit, comprising:
a sensing circuit including a differentiator configured to differentiate a voltage difference between both ends of a sensing resistor connected to a touch wire and an integrator configured to integrate a signal output from the differentiator; and
a driving circuit configured to control an integration time of the integrator based on a positive peak value or a negative peak value of the signal output from the differentiator.

2. The touch sensor driving circuit according to claim 1, wherein the integration time is set to be before a time at which at least one positive peak value or at least one negative peak value is output and to be in a time range determined in advance.

3. The touch sensor driving circuit according to claim 1, wherein the sensing circuit includes:
a first amplifier configured to amplify and output the voltage difference between both ends of the sensing resistor;
the differentiator configured to differentiate and output a signal output from the first amplifier;
a switch configured to separate a positive signal and a negative signal of the signal output from the differentiator;
a first integrator configured to integrate and output the positive signal separated from the switch;
a second integrator configured to integrate and output the negative signal separated from the switch; and
a third amplifier configured to amplify and output a difference between a signal output from the first integrator and a signal output from the second integrator.

4. The touch sensor driving circuit according to claim 3, wherein the switch includes:
a first switch configured to separate the positive signal of the signal output from the differentiator; and
a second switch configured to separate the negative signal of the signal output from the differentiator.

5. The touch sensor driving circuit according to claim 4, wherein the sensing circuit further includes:
a second amplifier configured to receive and amplify the signal output from the differentiator and output the amplified signal to the switch.

6. The touch sensor driving circuit according to claim 5, wherein:
the first amplifier includes an operational amplifier, and
the operational amplifier includes an inverting terminal connected to one end of the sensing resistor connected to the touch wire and a non-inverting terminal connected to the other end of the sensing resistor to which a modulated low potential voltage is applied.

7. The touch sensor driving circuit according to claim 5, wherein:
the differentiator includes an operational amplifier, a capacitor, and a resistor,
the operational amplifier includes an inverting terminal connected to the capacitor and a non-inverting terminal to which a reference voltage is applied,
the capacitor is connected between an output end of the first amplifier and the inverting terminal of the operational amplifier, and
the resistor is connected between an output end and the inverting terminal of the operational amplifier.

8. The touch sensor driving circuit according to claim 5, wherein:
the second amplifier includes an operational amplifier, a first resistor, and a second resistor,
the operational amplifier includes an inverting terminal connected to the first resistor and a non-inverting terminal to which a reference voltage is applied,
the first resistor is connected between an output end of the differentiator and the inverting terminal of the operational amplifier, and
the second resistor is connected between an output end and the inverting terminal of the operational amplifier.

9. The touch sensor driving circuit according to claim 5, wherein:
the first integrator includes a first operational amplifier, a first resistor, and a first capacitor,
the first operational amplifier includes an inverting terminal connected to the first resistor and a non-inverting terminal to which a reference voltage is applied,
the first resistor is connected between the first switch and the inverting terminal of the first operational amplifier,
the first capacitor is connected between an output end and the inverting terminal of the first operational amplifier,
the second integrator includes a second operational amplifier, a second resistor, and a second capacitor,
the second operational amplifier includes an inverting terminal connected to the second resistor and a non-inverting terminal to which the reference voltage is applied,
the second resistor is connected between the second switch and the inverting terminal of the second operational amplifier, and
the second capacitor is connected between an output end and the inverting terminal of the second operational amplifier.

10. The touch sensor driving circuit according to claim 5, wherein:
the third amplifier includes an operational amplifier, and
the operational amplifier includes an inverting terminal connected to an output end of the first integrator and a non-inverting terminal connected to an output end of the second integrator.

11. The touch sensor driving circuit according to claim 1, wherein the sensing circuit includes:
an (1-1)th amplifier configured to amplify and output a voltage difference between both ends of a first sensing resistor connected to a first touch wire;
a (1-2)th amplifier configured to amplify and output a voltage difference between both ends of a second sensing resistor connected to a second touch wire;
a first differentiator configured to differentiate and output a signal output from the (1-1)th amplifier;
a second differentiator configured to differentiate and output a signal output from the (1-2)th amplifier;
a second amplifier configured to amplify and output a difference between a signal output from the first differentiator and a signal output from the second differentiator;
a switch configured to separate a positive signal or a negative signal of a signal output from the second amplifier;
a first integrator configured to integrate and output a signal separated from the switch;
a second integrator configured to integrate and output a voltage connected to a ground or in a floating state; and
a third amplifier configured to amplify and output a difference between a signal output from the first integrator and a signal output from the second integrator.

12. The touch sensor driving circuit according to claim 1, wherein the sensing circuit includes:
an (1-1)th amplifier configured to amplify and output a voltage difference between both ends of a first sensing resistor connected to a first touch wire;
a (1-2)th amplifier configured to amplify and output a voltage difference between both ends of a second sensing resistor connected to a second touch wire;
a first differentiator configured to differentiate and output a signal output from the (1-1)th amplifier;
a second differentiator configured to differentiate and output a signal output from the (1-2)th amplifier;
a second amplifier configured to amplify and output a difference between a signal output from the first differentiator and a signal output from the second differentiator;
a first switch configured to separate a positive signal of a signal output from the second amplifier;
a second switch configured to separate a negative signal of the signal output from the second amplifier;
an (1-1)th integrator configured to integrate and output the positive signal separated from the first switch;
a (1-2)th integrator configured to integrate and output a voltage connected to a ground or in a floating state;
a (2-1)th integrator configured to integrate and output the negative signal separated from the second switch;
a (2-2)th integrator configured to integrate and output the voltage connected to the ground or in the floating state;
a (3-1)th amplifier configured to amplify and output a difference between a signal output from the (1-1)th integrator and a signal output from the (1-2)th integrator;
a (3-2)th amplifier configured to amplify and output a difference between a signal output from the (2-1)th integrator and a signal output from the (2-2)th integrator; and
a fourth amplifier configured to amplify and output a difference between a signal output from the (3-1)th amplifier and a signal output from the (3-2)th amplifier.

13. A display device, comprising:
a display panel including a plurality of pixels provided in areas where a plurality of data lines and a plurality of gate lines intersect each other and connected to one cathode electrode; and
a touch sensor driving circuit configured to sense a current change of a touch wire connected to the cathode electrode,
wherein the touch sensor driving circuit includes:
a sensing circuit including a differentiator configured to differentiate a voltage difference between both ends of a sensing resistor connected to the touch wire and an integrator configured to integrate a signal output from the differentiator; and
a driving circuit configured to control an integration time of the integrator based on a positive peak value or a negative peak value of the signal output from the differentiator.

14. The display device according to claim 13, wherein the integration time is set to be before a time at which at least one positive peak value or at least one negative peak value is output and to be in a time range determined in advance.

15. The display device according to claim 13, wherein the sensing circuit includes:
a first amplifier configured to amplify and output the voltage difference between both ends of the sensing resistor;
the differentiator configured to differentiate and output a signal output from the first amplifier;
a switch configured to separate a positive signal and a negative signal of the signal output from the differentiator;
a first integrator configured to integrate and output the positive signal separated from the switch;
a second integrator configured to integrate and output the negative signal separated from the switch; and
a third amplifier configured to amplify and output a difference between a signal output from the first integrator and a signal output from the second integrator.

16. The display device according to claim 15, wherein the sensing circuit further includes a second amplifier configured to receive and amplify the signal output from the differentiator and output the amplified signal to the switch.

17. The display device according to claim 13, wherein the sensing circuit includes:
an (1-1)th amplifier configured to amplify and output a voltage difference between both ends of a first sensing resistor connected to a first touch wire;
a (1-2)th amplifier configured to amplify and output a voltage difference between both ends of a second sensing resistor connected to a second touch wire;
a first differentiator configured to differentiate and output a signal output from the (1-1)th amplifier;
a second differentiator configured to differentiate and output a signal output from the (1-2)th amplifier;
a second amplifier configured to amplify and output a difference between a signal output from the first differentiator and a signal output from the second differentiator;
a switch configured to separate a positive signal or a negative signal of a signal output from the second amplifier;
a first integrator configured to integrate and output a signal separated from the switch;
a second integrator configured to integrate and output a voltage connected to a ground or in a floating state; and
a third amplifier configured to amplify and output a difference between a signal output from the first integrator and a signal output from the second integrator.

18. The display device according to claim 13, wherein the sensing circuit includes:
an (1-1)th amplifier configured to amplify and output a voltage difference between both ends of a first sensing resistor connected to a first touch wire;
a (1-2)th amplifier configured to amplify and output a voltage difference between both ends of a second sensing resistor connected to a second touch wire;
a first differentiator configured to differentiate and output a signal output from the (1-1)th amplifier;
a second differentiator configured to differentiate and output a signal output from the (1-2)th amplifier;
a second amplifier configured to amplify and output a difference between a signal output from the first differentiator and a signal output from the second differentiator;
a first switch configured to separate a positive signal of a signal output from the second amplifier,
a second switch configured to separate a negative signal of the signal output from the second amplifier;
an (1-1)th integrator configured to integrate and output the positive signal separated from the first switch;
a (1-2)th integrator configured to integrate and output a voltage connected to a ground or in a floating state;
a (2-1)th integrator configured to integrate and output the negative signal separated from the second switch;
a (2-2)th integrator configured to integrate and output the voltage connected to the ground or in the floating state;
a (3-1)th amplifier configured to amplify and output a difference between a signal output from the (1-1)th integrator and a signal output from the (1-2)th integrator;
a (3-2)th amplifier configured to amplify and output a difference between a signal output from the (2-1)th integrator and a signal output from the (2-2)th integrator; and
a fourth amplifier configured to amplify and output a difference between a signal output from the (3-1)th amplifier and a signal output from the (3-2)th amplifier.
